(19) United States
(12) Patent Application Publication
(10) Pub. No.: US 2024/0321530 A1
(43) Pub. Date: Sep. 26, 2024

(54) METHOD OF ASSEMBLING A TEMPERATURE-DEPENDENT SWITCH

(71) Applicant: Marcel P. Hofsaess, Steintahleben (DE)

(72) Inventor: Marcel P. Hofsaess, Steintahleben (DE)

(21) Appl. No.: 18/612,105

(22) Filed: Mar. 21, 2024

(30) Foreign Application Priority Data
Mar. 23, 2023 (DE) 10 2023 107 381.8

(51) Int. Cl. H01H 11/00; H01H 37/54

(52) U.S. Cl. CPC H01H 11/00; H01H 37/5427

(57) ABSTRACT

A method of assembling a temperature-dependent switch, comprising the steps of: (i) providing a switch housing having first and second electrodes and a temperature-dependent switching mechanism arranged in the switch housing, wherein the switching mechanism switches in a temperature-dependent manner between a closed state, which the switching mechanism assumes below a response temperature and in which the switching mechanism establishes an electrically conductive connection between the first and second electrodes, and an open state, which the switching mechanism assumes above the response temperature and in which the switching mechanism disconnects the electrically conductive connection; (ii) heating the switching mechanism to an assembly temperature above the response temperature to bring the switching mechanism in the open state; and (iii) attaching, by a material-bonded connection, a first external terminal to the first electrode or to a part electrically connected with the first electrode, while the switching mechanism is in the open state.

### CROSS-REFERENCE TO RELATED APPLICATIONS

This application claims priority from German patent application DE 10 2023 107 381.8, filed on Mar. 23, 2023. The entire content of this priority application is incorporated herein by reference.

### FIELD

The present disclosure relates to a method of assembling a temperature-dependent switch.

### BACKGROUND

An exemplary temperature-dependent switch is disclosed in DE 10 2019 110 448 A1.

Such temperature-dependent switches are used in a principally known manner to monitor the temperature of a device. For this purpose, the switch is brought into thermal contact with the device to be protected, e.g. via one of its outer surfaces, so that the temperature of the device to be protected influences the temperature of the switching mechanism arranged inside the switch.

The switch is typically connected electrically in series into the supply circuit of the device to be protected via connecting cables, so that the supply current of the device to be protected flows through the switch below the response temperature of the switching mechanism.

Such temperature-dependent switches comprise a temperature-dependent switching mechanism which is arranged in the switch housing and which, depending on its temperature, opens or closes an electrically conductive connection between two electrodes of the switch. More precisely, the temperature-dependent switching mechanism is configured to switch in a temperature-dependent manner between a closed state, which the switching mechanism assumes below a response temperature and in which the switching mechanism establishes the electrically conductive connection between the two electrodes, and an open state, which the switching mechanism assumes above the response temperature and in which the switching mechanism disconnects the electrically conductive connection.

The term “electrode” is to be interpreted in its most general way in this respect. This is an electrical contact point which serves to connect the switch to the electrical device to be protected, or which is in electrically conductive connection with such an external terminal of the switch. The electrodes can be led from outside into the interior of the switch housing, fixed to the switch housing or formed by parts of the switch housing itself.

To enable the above-mentioned temperature-dependent switching function, the temperature-dependent switching mechanism arranged inside the switch housing usually comprises a bimetal part that deforms abruptly from its low-temperature state to its high-temperature state upon reaching the response temperature, and thereby lifts off a movable contact part, which is arranged on a component that can move relative to the switch housing, from a stationary contact. The stationary contact is connected to one of the two electrodes, while the movable contact part interacts either with the bimetal part or with a spring part assigned to the bimetal part.

Constructions are also known in which the movable component of the temperature-dependent switching mechanism is designed as a contact bridge, which is carried by the bimetal part and directly establishes an electrical connection between the two electrodes. A temperature-dependent switch having a switching mechanism designed in such a way is disclosed, for example, in DE 197 08 436 A1.

In the two construction types mentioned above, the bimetal part is preferably configured as a bimetallic disc which, in the low-temperature state, preferably lies force-free in the switching mechanism. The spring part, which is preferably configured as a snap-action spring disc, is mechanically coupled with the bimetal part. The spring part is clamped in the switch housing, connected to it by a material bond or inserted into the switch housing.

In principle, however, it is also possible to completely dispense with the spring part, which is the case in particular in more cost-effective variants of such temperature-dependent switches. In such a case, the function of the spring part is taken over by the bimetal part. An exemplary temperature-dependent switch of this type is disclosed in DE 20 2009 012 616 U1.

Regardless of the construction type of the temperature-dependent switching mechanism, such temperature-dependent switches are typically electrically connected to the device to be protected via electrical supply lines or connecting parts that are fixed to the two electrodes. As a rule, flexible connection strands, rigid connection lugs or a connection cable are connected to the electrodes directly with a material connection. The strands, terminal lugs or cables are often soldered or welded to the switches known from the prior art.

However, soldering or welding of the supply lines or connecting parts has proven to be problematic in many respects.

The soldering processes commonly used are difficult to automate and are not environmentally friendly, in particular due to the lead-containing solder and the additional soldering flux used. In addition, cold solder joints can occur, which should be avoided at all costs.

An improved material-locking connection of the supply lines or connecting parts could therefore be realized in principle via welded connections, but these also have various disadvantages. In particular, the common welding processes pollute the environment and are also time-consuming and costly. Furthermore, such welding processes lead to the switch heating up considerably, which can lead to the welding triggering a switching operation of the temperature-dependent switching mechanism, which is generally undesirable.

Tests carried out by the applicant, in which terminal lugs or stranded wires were soldered or welded to the switch housing, have shown that the heat generated in the process can also cause the stationary contact inside the switch housing, with which the temperature-dependent switching mechanism interacts, to become detached from the electrode assigned to it.

The heat development can also cause the stationary contact and the movable contact part of the temperature-dependent switching mechanism to fuse together undesirably or at least change their geometry in such a way that the pre-assembled switches no longer switch or at least no longer switch reliably.

Furthermore, the heat development can lead to the bimetal part and/or the spring part being affected, so that the required switching properties of the switching mechanism change undesirably.

In the worst case, all of this can lead to a total functional failure of the switch.

The heat generated inside the switch housing is particularly pronounced if the switch housing is made of metal and the supply cables or connecting parts are welded or soldered directly to the switch housing. Due to the very good heat conduction properties of the metal, this results in particularly strong heat development inside the switch housing. This is all the more critical as the supply lines or connecting parts are usually only attached to the housing after the switching mechanism has already been mounted in the housing or the housing has been closed, i.e. after the switch itself is already present as a semi-finished component. Whether the heat generated inside the switch leads to any of the above-mentioned damage can then only be checked to a limited extent or at least only with great effort.

To prevent this, the supply lines or connecting parts are often fixed to the switch housing in advance, i.e. before the temperature-dependent switching mechanism is installed. However, this also comes with various disadvantages. On the one hand, it makes the handling of the switch more difficult during assembly, as the supply lines/connecting parts “get in the way” when the switching mechanism is installed in the switch housing. In addition, to achieve a sealed switch housing, it is easier to first insert the switching mechanism into the switch housing and seal the switch housing and then attach the supply lines or connecting parts to the switch housing.

In order to enable such an attachment of the supply lines or connecting parts to the switch housing after installation of the temperature-dependent switching mechanism and yet avoid the above-mentioned problem of undesirable heat development in the switch housing, DE 10 2019 110 448 A1, mentioned at the outset, proposes attaching the supply lines or connecting parts to the switch housing by means of ultrasonic welding. Compared to conventional welding methods, ultrasonic welding generates significantly less heat. It has been shown that most of the above-mentioned problems can be prevented in this way. However, the use of ultrasonic welding processes is relatively expensive, as very special welding tools are required.

### SUMMARY

It is an object to provide an improved method of assembling a temperature-dependent switch, which overcomes the above-mentioned problems. In particular, the method is intended to enable a safe and sustainable attachment of the external terminals to the switch without thereby damaging the temperature-dependent switching mechanism arranged inside the switch.

According to an aspect, a method of manufacturing/assembling a temperature-dependent switch is provided, comprising the following steps:
(i) providing a switch housing having a first electrode, a second electrode and a temperature-dependent switching mechanism arranged in the switch housing, wherein the temperature-dependent switching mechanism is configured to switch in a temperature-dependent manner between a closed state and an open state, wherein below a response temperature the temperature-dependent switching mechanism is in the closed state, in which the temperature-dependent switching mechanism establishes an electrically conductive connection between the first electrode and the second electrode, and above the response temperature the temperature-dependent switching mechanism is the open state, in which the temperature-dependent switching mechanism disconnects the electrically conductive connection;
(ii) heating the temperature-dependent switching mechanism to an assembly temperature above the response temperature to bring the temperature-dependent switching mechanism in the open state; and
(iii) joining a first external terminal to the first electrode or to a part electrically connected with the first electrode, while the temperature-dependent switching mechanism is in the open state.

Thus, in the presented method, it is also proposed to first install the switching mechanism in the switch housing and then to attach the first external terminal to the switch prefabricated as a semi-finished product by means of joining with the application of heat (e.g. by soldering or welding).

However, the applicant has recognized that the above-mentioned harmful effects, which can arise for the switching mechanism arranged inside the switch housing due to the heat generated by the joining process, can surprisingly be reduced or even completely avoided by additionally heating the switching mechanism before the first external terminal is attached in order to bring it to a temperature above the response temperature of the switching mechanism, which temperature is herein denoted as “assembly temperature”.

This heating of the switching mechanism in advance leads to the switching mechanism being deliberately brought into its open state. This not only interrupts the electrically conductive connection between the two electrodes, but also the heat conductive connection between the two electrodes caused by the switching mechanism. As a result, the heat generated when the first external terminal is attached by material-locking joining no longer has a damaging effect on the devices of the temperature-dependent switching mechanism, as this is already open and its components are not pressed against each other, unlike in the closed state.

Accordingly, the movable contact part typically provided on the switching mechanism is already lifted off the stationary contact part, against which the movable contact part rests in the closed state of the switching mechanism, before the first external terminal is attached. Direct heat conduction between the stationary contact part and the movable contact part is therefore excluded. Accordingly, it is also impossible for the movable contact part of the switching mechanism to be fused or welded with the stationary contact part or with the first electrode due to the heat generated when the first external terminal is attached to the first electrode.

Furthermore, the fragile devices of the switching mechanism (e.g. the bimetal part and the spring part) are typically further away from the joining point of the first external terminal or further away from the first electrode in the open state of the switching mechanism than in the closed state of the switching mechanism. Thus, the fragile devices of the switching mechanism are effectively protected from the heat generated during material-locking joining by the prior heating of the switching mechanism, during which the switching mechanism is brought into the open state.

Furthermore, the presented method has the advantage that an undesired switching operation of the switching mechanism, which can be caused by the heat development when attaching the first external terminal, is also effectively prevented, since the switching mechanism is already in its open state at this time and also remains in this open state due to the additional heat input during the attachment of the first external terminal.

In a refinement, the attaching of the first external terminal by material-locking joining with the application of heat comprises a soldering process or a welding process.

Since the switching mechanism is already in its open state during this process and the heat thereby introduced into the interior of the switch housing, as mentioned above, no longer has any damaging effects on the switching mechanism, conventional soldering and welding processes can be inserted with low costs. These material-locking joining processes can be automated, which leads to a further cost advantage.

In a further refinement, the switching mechanism is heated to the assembly temperature above the response temperature by heating the switch housing and the switching mechanism arranged therein by an external heat source.

The switching mechanism arranged inside the switching mechanism is therefore heated indirectly from the outside. This external heating leads to a regular switching operation of the switching mechanism, which does not cause any damage to the switching mechanism itself. Heating by means of an external heat source is possible with a comparatively low energy consumption in a cost-effective and automated manner.

Preferably, the temperature to which the switching mechanism is heated in method step (ii) is higher than 100° C. Particularly preferably, the switching mechanism is heated to a temperature higher than 150° C. in method step (ii).

This ensures that the temperature-dependent switching mechanism is brought into its open state without any doubt before performing method step (iii).

In a further refinement, it is preferred that the switching mechanism is heated to the assembly temperature above the response temperature by passing the switch housing and the switching mechanism arranged therein in an automated manner through a heating section.

Such a heating section can, for example, be designed as a heating tunnel through which the switch housing automatically passes. In this way, the switch housing can be heated continuously and thus harmlessly. Such a heating section can also be integrated into an automated production or assembly line without great effort.

The attachment of the first external terminal by material-locking joining with the application of heat is preferably performed automatically after passing through the heating section.

In a further refinement, the method comprises the following further step: (iv) attaching, by material-locking joining with the application of heat, a second external terminal to the second electrode or to a part electrically connected to the second electrode.

This additional step (iv) can take place before step (ii), i.e. before the switching mechanism is brought into its open state by external heating. This is possible, in particular, if the heat generated during the material-locking joining of the second external terminal does not have a too great damaging effect on the switching mechanism arranged inside the switch housing. This, in turn, is the case in particular if the second external terminal is attached at a point on the switch that is further away from the switching mechanism and/or is not in direct thermal contact with the switching mechanism.

However, this type of refinement is particularly advantageous for switches in which the two electrodes are arranged on opposite sides of the switch housing. In this case, it is often the case that the fragile components of the switching mechanism have a larger distance from the second electrode in the closed state than in the open state, while they have a larger distance from the first electrode in the open state than in the closed state.

If the second external terminal is attached to the second electrode or a component connected to the second electrode while the switching mechanism is in the closed state, and the first external terminal is attached to the first electrode or a component connected to the first electrode after the switching mechanism has been brought to its open state, the fragile components of the switching mechanism are as far away as possible from the respective joining point during both joining processes. The heat generated during the two joining processes thus has as little harmful effect as possible on the fragile components of the switching mechanism.

However, depending on the structure of the switch or the structure of the switching mechanism inside it, it can also be advantageous for both joining processes, i.e. the attachment of both external terminals, to take place after process step (ii), i.e. at a time when the switching mechanism is already in its open state.

In a further refinement, the switch housing comprises a lower part and a cover part which closes the lower part and is electrically insulated from the lower part, wherein the cover part is at least partially made of electrically conductive material, and wherein the first electrode is arranged on the cover part.

In this refinement, the cover part of the switch housing is preferably made of metal. Accordingly, the heat generated during the joining process during method step (iii) is particularly high, so that the method has a particularly advantageous effect.

The lower part can also be made of electrically conductive material, for example metal. An outer side of the cover part facing away from the inside of the switch housing and an outer side of the lower part facing away from the inside of the switch housing can be used as contact connections for the external terminals of the switch. The cover and lower part can therefore themselves form the connection electrodes of the switch.

The first electrode can comprise a contact part which extends from the inside of the switch housing through the cover part to the outside. This contact part can therefore be a type of piercing or shoot-through contact, which forms the first electrode on the inside and comprises a contact surface for the first external terminal on the outside. In such a case, the heat conduction that occurs between the joining point and the first electrode during joining during method step (iii) is particularly high, so that in this case it is particularly advantageous if the switching mechanism has already been brought into its open state in advance.

In a further refinement, the method comprising steps (i)-(iii) is repeated for a plurality of temperature-dependent switches, wherein the switch housings of the plurality of temperature-dependent switches are fixed to a common conveyor belt while steps (i)-(iii) are carried out.

This enables an automated assembly of the switch.

Preferably, the conveyor belt comprises a plurality of receptacles, to each of which one of the switch housings of the plurality of temperature-dependent switches is fixed, wherein each of the plurality of receptacles comprises a connecting piece which is electrically connected to the second electrode of the respective switch housing and to which the second external terminal is attached by material-locking joining with the application of heat.

This connecting piece enables a very simple way of attaching the second external terminal. The receptacles provided on the conveyor belt, which are preferably ring-shaped, are therefore not only used to transport the switches, but also to simplify the joining process for attaching the second external terminal to the individual switches.

In a further refinement, the temperature-dependent switching mechanism comprises a bimetal part.

In the present context, a bimetal part is understood to be a multi-layered, active, sheet-shaped device comprising two, three or four inseparably connected components with different coefficients of thermal expansion. The connection of the individual layers of metals or metal alloys is materially or positively locking and is achieved, for example, by rolling.

Bimetal parts such as these comprise a first geometric conformation in their low-temperature state and a second geometric conformation in their high-temperature state, between which they switch in a hysteresis-like manner depending on the temperature. When the temperature changes above the response temperature or below their reset temperature, such bimetal parts snap into the other conformation.

In a further refinement, the temperature-dependent switching mechanism comprises a spring part interacting with the bimetal part.

The bimetal part is preferably a temperature-dependent bimetallic snap-action disc. The spring part is preferably a temperature-independent snap-action spring disc.

Further features and advantages are apparent from the accompanying drawings and the description hereinafter.

It is to be understood that the features mentioned above and those to be explained below can be used not only in the combination indicated in each case, but also in other combinations or on their own, without departing form the scope of the present disclosure.

### BRIEF DESCRIPTION OF THE DRAWINGS

FIG. 1 shows a schematic sectional view of an exemplary temperature-dependent switch which can be assembled with the presented method, wherein the switch is in its low-temperature state;

FIG. 2 shows a schematic sectional view of the switch shown in FIG. 1, wherein the switch is in its high-temperature state;

FIG. 3 shows a conveyor or assembly belt with several temperature-dependent switches to schematically illustrate the method according to an embodiment;

FIG. 4 shows a schematic top view of the conveyor belt shown in FIG. 3 without temperature-dependent switches inserted therein; and

FIG. 5 shows a simplified flow chart illustrating the method steps of the method according to an embodiment.

### DESCRIPTION OF PREFERRED EMBODIMENTS

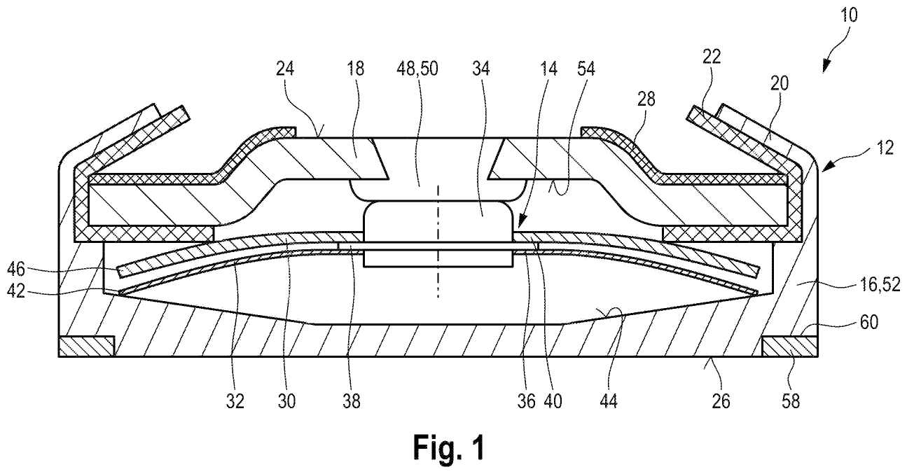

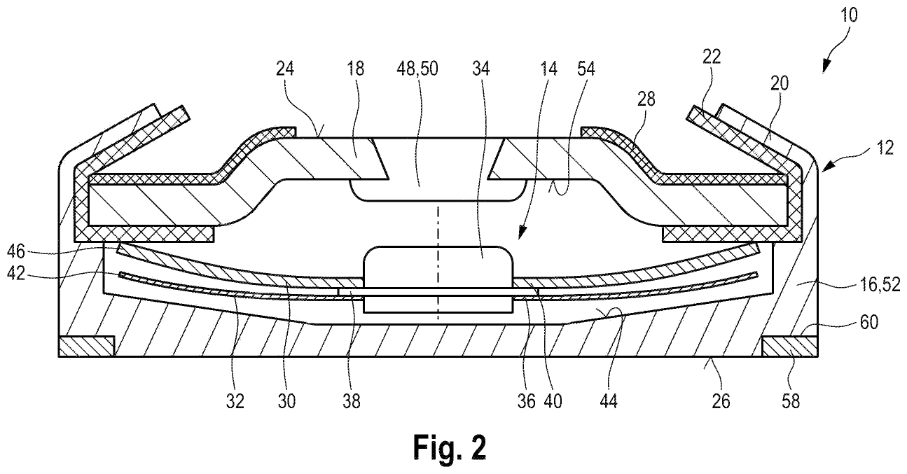

FIGS. 1 and 2 show an exemplary temperature-dependent switch that can be assembled with the herein presented method. The switch is denoted in its entirety with the reference numeral 10.

FIG. 1 shows the low temperature state of switch 10. FIG. 2 shows the high temperature state of switch 10.

It is understood that the switch 10 shown in FIGS. 1 and 2 is only one example of various possible temperature-dependent switches that can be assembled with the method. However, the manufacturing or assembly method can in principle also be used for various other temperature-dependent switches that have a different design than the switch 10 shown in FIGS. 1 and 2. However, the switch 10 shown in FIGS. 1 and 2 is described in the following as an example of a possible temperature-dependent switch in order to explain the basic structure and function of such a temperature-dependent switch.

The switch 10 comprises a switch housing 12, inside which a temperature-dependent switching mechanism 14 is arranged. The switch housing 12 comprises a pot-like lower part 16 and a cover part 18, which is held on the lower part 16 by a bent or flanged upper edge 20 of the lower part 16.

In the example of the switch 10 shown in FIGS. 1 and 2, both the lower part 16 and the cover part 18 are made of an electrically conductive material, preferably metal. An insulating foil 22 is arranged between the lower part 16 and the cover part 18. The insulating foil 22 provides electrical insulation of the lower part 16 from the cover part 18. Likewise, the insulating foil 22 provides a mechanical seal that prevents liquids or contaminants from entering the interior of the switch housing 12 from the outside.

Since the lower part 16 and the cover part 18 in this example are each made of electrically conductive material, thermal contact to an electrical device to be protected can be made via their outer surfaces. The outer surfaces also serve as the electrical external terminal of the switch 10. For example, a first electrical external terminal can be attached to the switch 10 on the outer surface 24 of the cover part 18 and a second electrical external terminal can be attached to the outer surface 26 of the lower part 16.

A further insulation layer 28 is arranged on the outside of the cover part 18 in the example of the switch 10 shown in FIGS. 1 and 2.

The switching mechanism 14 is clamped between the lower part 16 and the cover part 18. The switching mechanism 14 comprises a bimetal part 30, a spring part 32 and a movable contact part 34.

The bimetal part 30 comprises a temperature-dependent bimetallic snap-action disc with a central opening provided therein, with which the bimetallic snap-action disc is slipped over the movable contact part 34.

The spring part 32 comprises a temperature-independent snap-action spring disc, which is also fitted over the movable contact part 34 with a centric opening provided therein, but from an opposite bottom side. The two snap-action discs 30, 32 are thus fitted over the movable contact part 34 from opposite sides.

In the low-temperature state of the switch 10 shown in FIG. 1, the snap-action spring disc 32 supports the movable contact part 34 from below by pressing with its inner edge area 36 from below against a circumferential, annular collar 38 of the movable contact part 34. Here, the snap-action spring disc 32 is supported with its outer, circumferential edge 42 on the inner base 44 of the lower part 16.

In this state of the switch 10, the inner edge region 40 of the bimetallic snap-action disc 30 preferably rests freely on this collar 38 of the movable contact part 34 from the opposite top side. The outer, circumferential edge 46 of the bimetallic snap-action disc 30 hangs freely into the interior of the housing 12. In this type of switch 10, the bimetallic snap-action disc 30 is thus stored in the switch housing 12 almost force-free in the low-temperature state, without being firmly clamped therein.

In the low-temperature state of the switch 10 shown in FIG. 1, the temperature-dependent switching mechanism 14 establishes an electrically conductive connection between the two electrodes 50, 52 of the switch 10 by pressing the movable contact part 34 against a stationary contact part 48 arranged on the cover part 18. The contact pressure with which the movable contact part 34 is pressed against the stationary contact part 48 in the low-temperature state of the switch 10 is effected in the switch 10 by the snap-action spring disc 32.

Parts of the switch housing 12 function here as electrodes 50, 52, between which the temperature-dependent switching mechanism 14 establishes the electrically conductive connection in the low-temperature state of the switch 10. More precisely, in the herein shown switch 10, the stationary contact part 48 functions as the first electrode 50 and the lower part 16 of the switch housing 12 or the inner bottom 44 of the lower part 16 functions as the second electrode 52.

If, starting from the low-temperature state of the switch 10 shown in FIG. 1, the temperature of the device to be protected and thus the temperature of the switch 10 and the bimetallic snap-action disc 30 arranged therein increases to the response temperature of the switching mechanism 14, which corresponds to the response temperature of the bimetallic snap-action disc 30, or above this response temperature, the bimetallic snap-action disc 30 snaps from its convex low-temperature configuration shown in FIG. 1 into its concave high-temperature configuration, which is shown in FIG. 2. During this snap-action, the bimetallic snap-action disc 30 is supported with its outer edge 46 on the bottom side 54 of the cover part 18. With its center or its inner edge area 40, the bimetallic snap-action disc 30 thereby presses the movable contact part 34 downwards and lifts the movable contact part 34 off the stationary contact part 48. As a result, the spring snap-disc 32 simultaneously bends downwards at its center, so that the spring snap-disc 32 snaps over from its first geometric configuration shown in FIG. 1 into its second geometric configuration shown in FIG. 2. The electrically conductive connection between the two electrodes 50, 52 of the switch 10 previously established via the switching mechanism 14 is thus interrupted.

The temperature-dependent switching mechanism 14 is thus configured to establish and disconnect the electrically conductive connection between the two electrodes 50, 52 in a temperature-dependent manner. Below the response temperature of the bimetallic snap-action disc 30, the switching mechanism 14 is in its low-temperature state shown in FIG. 1, in which it establishes the electrically conductive connection between the two electrodes 50, 52. As soon as the response temperature of the bimetallic snap-action disc 30 is exceeded, the bimetallic snap-action disc 30 brings the switching mechanism 14 into the high-temperature state shown in FIG. 2, in which the electrically conductive connection between the two electrodes 50, 52 is interrupted.

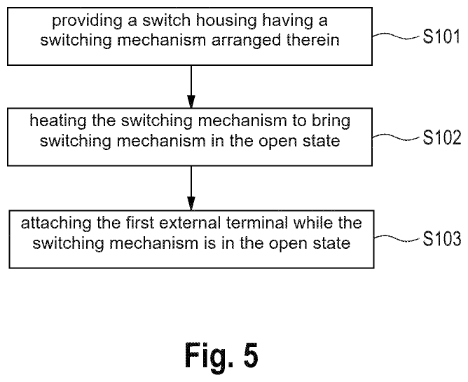

FIG. 5 shows schematically, in the form of a simplified flow chart, steps for the manufacture/assembly of such a temperature-dependent switch 10. In the first step S101, the switch housing 12 with the switching mechanism 14 arranged therein is provided. This first step S101 comprises inserting the switching mechanism 14 into the switch housing 12 and closing the switch housing 12 in order to produce the assembly state of the switch 10 shown in FIGS. 1 and 2.

Subsequently, in step S102, the switching mechanism 14 is intentionally heated to an assembly temperature above the response temperature of the bimetallic snap-action disc 30 to bring the switching mechanism 14 into its open state shown in FIG. 2. In this open state of the switching mechanism 14, the first external terminal is then fixed to the first electrode 50 of the switch 10 in step S103.

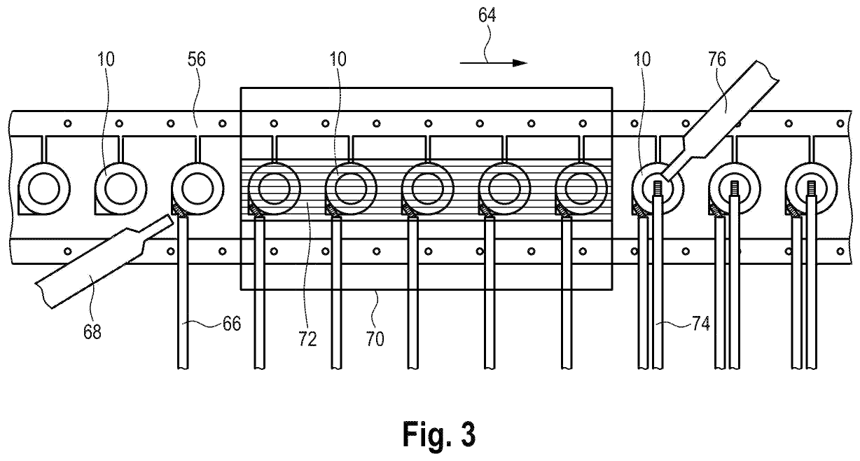

FIG. 3 schematically shows the sequence of this assembly process using the example of an automated assembly, in which a plurality of such temperature-dependent switches 10 are mounted one after the other on a movable conveyor belt 56. The first method step S101 of providing the switch housing 12 with the switching mechanism 14 arranged therein is not explicitly shown in FIG. 3, as this can be realized in a conventional automated or manual way. FIG. 3 visualizes in particular the assembly process during the method steps S102 and S103.

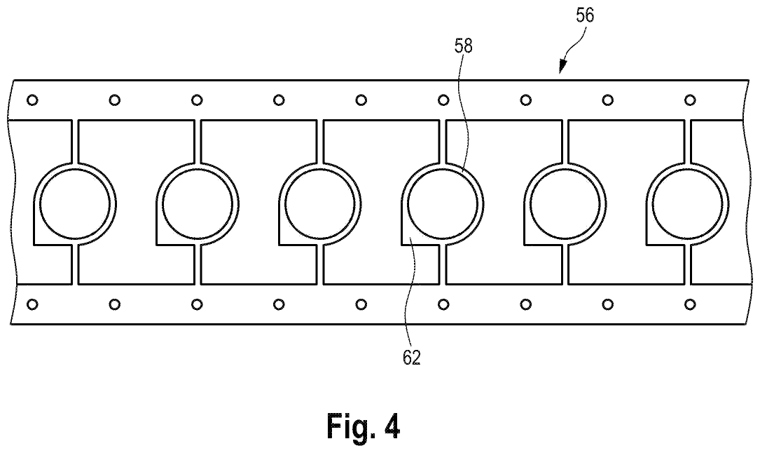

In the assembly process shown schematically in FIG. 3, the individual switches 10 with their respective switch housings 12 are each fixed individually to the conveyor belt 56 in order to prevent the switches 10 from slipping or even getting lost. Preferably, the switches 10 are fixed to the conveyor belt 56 in a material-locking manner. For this purpose, the conveyor belt 56 comprises a plurality of receptacles 58, as can be seen in particular in FIG. 4, in which the conveyor belt 56 is shown in a top view from above without the switches 10 inserted therein.

The receptacles 58 are annular receptacles into which the switches 10 are inserted from above. Particularly preferably, the receptacles 58 are adapted to the diameters of the lower parts 16 of the switch housings 12. As shown in FIGS. 1 and 2, the lower part 16 of each switch 10 comprises a recessed, circumferential shoulder 60 on the bottom side, into which the annular receptacle 58 is fitted and is preferably soldered or welded thereto.

In addition, each of the receptacles 58 comprises a connecting piece 62 which, as explained in detail hereinafter, essentially serves to attach the second external terminal of the respective switch 10.

During the assembly process, the conveyor belt 56 is moved in the direction of arrow 64, so that the switches 10 fixed in the conveyor belt 56 pass through the individual assembly steps explained hereinafter.

First, the second external terminal 66, which is provided as a cable lug, a connection lug, a connection cable or a stranded wire, is connected to the second electrode 52 of the switch 10 in an electrically conductive manner. For this purpose, the second external terminal 66 is welded or soldered to the connecting piece 62, which in turn is fixed to the lower part 16 or the second electrode 52. This is indicated schematically in FIG. 3 by means of a first welding gun 68.

The second external terminal 66 is attached in the low-temperature state of the switch 10. This has the advantage that the greatest possible distance is thus maintained between the movable contact part 34 of the switching mechanism 14 and the welding point to which the second external terminal 66 is attached. The risk of the movable contact part 34 fusing with the stationary contact part 48 due to the heat thereby generated is thus reduced to a minimum.

The switches 10 are then brought into the high-temperature state by external heating, in which the respective switching mechanism 14 is in its open state shown in FIG. 2. This is done in the present case by passing the switches 10 through a heating tunnel or heating section 70. One or more external heat sources 72 are provided on this heating section 70, which are illustrated schematically in FIG. 3 by heating wires. However, it will be understood that the heat sources 72 can be any type of heat source, for example hot air heat sources, infrared heat sources, inductive heat sources, etc.

Preferably, the switches within the heating section 70 are continuously heated to an assembly temperature above the switching mechanism response temperature by means of the heat sources 72. Typically, heating to a temperature higher than 100° C. is sufficient for this purpose, for example heating to a temperature in the area of 150-270° C.

After passing through the heating section 70, the switching mechanisms 14 of all switches 10 are accordingly in their open or high temperature state. While the switching mechanisms 14 of the switches 10 are in this open state, the first external terminal 74, which is also provide as a cable lug, a connection strand, a regular cable or a connection lug, is welded or soldered to the top side of the stationary contact part 48, which functions as the first electrode 50, as shown in the right-hand edge of FIG. 3. This process is illustrated schematically in FIG. 3 by means of a second welding gun 76.

As can be seen particularly in FIG. 2, the movable contact part 34 of the switching mechanism 14 has a maximum distance from the stationary contact part 48 in the open state. In addition, there is no direct mechanical or thermal contact between the two contact parts 34, 48. Accordingly, the risk of the two contact parts 34, 48 fusing together due to the heat generated when the first external terminal 74 is attached is reduced to a minimum. The fragile components 30, 32, 34 of the switching mechanism 14 are thus protected in the best possible way from damage that can otherwise occur due to the extremely high heat development inside the switch housing 12.

The method thus enables an automated assembly/manufacture of temperature-dependent switches, which enables a stable and sustainable attachment of the external terminals 74, 66 and at the same time protects the temperature-dependent switching mechanism 14 provided in the switch in the best possible way.

As already mentioned, the assembly method is suitable not only for a temperature-dependent switch 10 as shown schematically in FIGS. 1 and 2, but also for various other temperature-dependent switches with similar/comparable switching properties.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of assembling a temperature-dependent switch, including the steps of:
providing a switch housing having a first electrode, a second electrode and a temperature-dependent switching mechanism arranged in the switch housing, wherein the temperature-dependent switching mechanism is configured to switch in a temperature-dependent manner between a closed state and an open state, below a response temperature the temperature-dependent switching mechanism is in the closed state, in which the temperature-dependent switching mechanism establishes an electrically conductive connection between the first electrode and the second electrode, and above the response temperature the temperature-dependent switching mechanism is the open state, in which the temperature-dependent switching mechanism disconnects the electrically conductive connection;
heating the temperature-dependent switching mechanism to an assembly temperature above the response temperature to bring the temperature-dependent switching mechanism in the open state; and
joining a first external terminal to the first electrode or to a part electrically connected with the first electrode, while the temperature-dependent switching mechanism is in the open state.

2. The method according to claim 1, wherein the joining of the first external terminal to the first electrode or to the part electrically connected with the first electrode comprises soldering or welding the first external terminal to the first electrode or to the part electrically connected to the first electrode.

3. The method according to claim 1, wherein the temperature-dependent switching mechanism is heated to the assembly temperature by heating the switch housing and the temperature-dependent switching mechanism arranged in the switch housing by an external heat source.

4. The method according to claim 1, wherein the assembly temperature is higher than 100° C.

5. The method according to claim 1, wherein the temperature-dependent switching mechanism is heated to the assembly temperature by passing the switch housing and the temperature-dependent switching mechanism arranged in the switch housing through a heating section.

6. The method according to claim 5, wherein the joining of the first external terminal to the first electrode or to the part electrically connected with the first electrode is performed after the switch housing and the temperature-dependent switching mechanism arranged in the switch housing has been passed through the heating section.

7. The method according to claim 1, wherein the method further includes:
joining a second external terminal to the second electrode or to a second part electrically connected with the second electrode.

8. The method according to claim 7, wherein the joining of the second external terminal to the second electrode or to the second part electrically connected with the second electrode is performed before the temperature-dependent switching mechanism is heated to the assembly temperature.

9. The method according to claim 1, wherein the switch housing comprises a lower part and a cover part, wherein the cover part closes the lower part, comprises an electrically conductive material and is electrically insulated from the lower part, and wherein the first electrode is arranged at the cover part.

10. The method according to claim 9, wherein the first electrode comprises a contact part which extends from inside of the switch housing through the cover part to outside of the switch housing.

11. The method according to claim 1, wherein the method is repeated for a plurality of temperature-dependent switches, and wherein the switch housing of each of the plurality of temperature-dependent switches is fixed to a conveyor belt while the method is carried out for each of the plurality of temperature-dependent switches.

12. The method according to claim 11, wherein the conveyor belt comprises a plurality of receptacles, to each of which one of the plurality of temperature-dependent switches is fixed, and wherein each of the plurality of receptacles comprises a connecting piece which is electrically connected to the second electrode of the respective one of the plurality of temperature-dependent switches.

13. The method according to claim 1, wherein the temperature-dependent switching mechanism comprises a bimetal part.

14. The method according to claim 13, wherein the temperature-dependent switching mechanism comprises a spring part interacting with the bimetal part.

15. The method according to claim 14, wherein the bimetal part comprises a temperature-dependent bimetallic snap-action disc and the spring part comprises a temperature-independent snap-action spring disc.
